(19) United States
(12) Patent Application Publication
(10) Pub. No.: US 2007/0220543 A1
(43) Pub. Date: Sep. 20, 2007

(54) Mirroring of live data to guide data in a broadcast system

(76) Inventors: David E. Shanks, Los Angeles, CA (US); Jon M. Dean, Torrance, CA (US); David E. Feldstein, Santa Monica, CA (US); Richard F. Purpura, Orange, CA (US); Matthew J. Thompson, Torrance, CA (US); Mark A. Shurgot, Los Angeles, CA (US); Craig Le, Temple City, CA (US)

Correspondence Address: THE DIRECTV GROUP INC, PATENT DOCKET ADMINISTRATION RE/R11/A109, P O BOX 956, EL SEGUNDO, CA, 90245-0956, US

(21) Appl. No.: 11/707,798

(22) Filed: Feb. 16, 2007

Related U.S. Application Data
(60) Provisional application No. 60/774,353, filed on Feb. 17, 2006.

(51) Int. Cl. H04N 7/16; H04N 7/167

(52) U.S. Cl. 725/28; 725/25; 725/31

(57) ABSTRACT

A viewership rating system presented on a monitor. A system in accordance with the present invention comprises a program guide, presented on the monitor, wherein the program guide comprises a plurality of broadcast programs, and a plurality of rating indicators, each of the plurality of rating indicators presented on the monitor in a respective fashion with the plurality of broadcast programs, wherein the plurality of rating indicators shows a relative popularity of each of the plurality of broadcast programs.

### BACKGROUND OF THE INVENTION

1. Field of the Invention.

The present invention relates generally to satellite video systems, and in particular, to a method, apparatus, and article of manufacture for determining viewership of individual programs in a real-time environment.

2. Description of the Related Art.

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to monitor 114 for viewing by a user. There can be more than one satellite transmitting from each orbital location and additional orbital locations without departing from the scope of the present invention.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Alternatively, uplink facilities 118 can send signals via cable 122 either in conjunction with uplink signals 116 or instead of uplink signals 116 to IRD 112, for display on monitor 114.

Each satellite 102-106 broadcasts downlink signals 120 in typically thirty-two (32) different frequencies, which are licensed to various users for broadcasting of programming, which can be audio, video, or data signals, or any combination. These signals are typically located in the Ku-band of frequencies, i.e., 11-18 GHz, or in the Ka-band of frequencies, i.e., 18-40 GHz, but typically 20-30 GHz.

As satellites 102-106 broadcast additional services and additional channels to viewers, viewers will like and expect to see programming on monitor 114 that relate to their specific needs and desires.

### SUMMARY OF THE INVENTION

To minimize the limitations in the prior art, and to minimize other limitations that will become apparent upon reading and understanding the present specification, the present invention comprises a viewership rating system presented on a monitor. A system in accordance with the present invention comprises a program guide, presented on the monitor, wherein the program guide comprises a plurality of broadcast programs, and a plurality of rating indicators, each of the plurality of rating indicators presented on the monitor in a respective fashion with the plurality of broadcast programs, wherein the plurality of rating indicators shows a relative popularity of each of the plurality of broadcast programs. Such a system further optionally includes the current viewership being determined by callback information gathered from a plurality of receivers that are receiving the broadcast programs, a cursor, wherein the cursor can select one of the plurality of broadcast programs, selection of one of the broadcast programs from the plurality of broadcast programs creating a new condition to be displayed on the monitor, the new condition comprising presenting the selected broadcast program on the monitor, an indicator showing a trend related to at least one broadcast program in the plurality of broadcast programs, the dynamic viewership rating system being accessed by a selection of a remote control guide button, and a separate remote control button selecting a separate page display directly from a guide data display.

Other features and advantages are inherent in the system disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2A illustrates a typical six-cell matrix with a generic video feed in accordance with the present invention;

FIG. 2B illustrates a remote control used in the present invention;

FIGS. 3A-3C illustrate on-monitor displays of a data presentation page in accordance with the present invention;

FIG. 4 shows a typical data flow for the present invention; and

FIG. 5 shows a guide data display of the present invention.

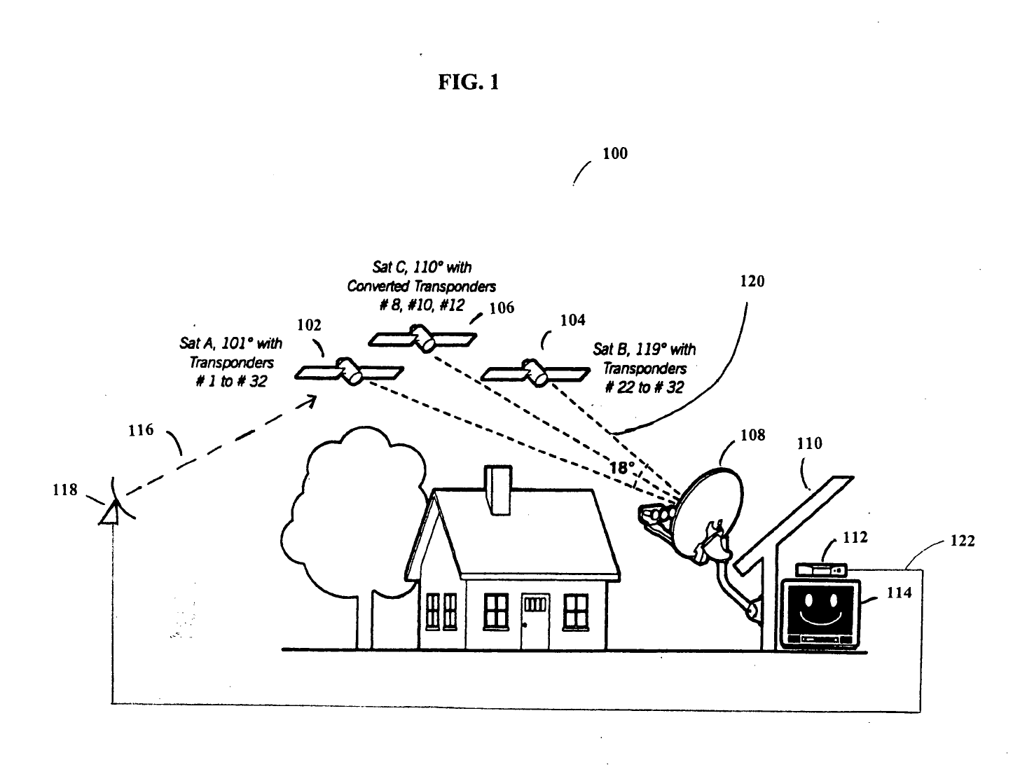

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

The present invention is a dynamic viewership rating system presented on a monitor.

Interactive Mosaic Channel Display Diagram

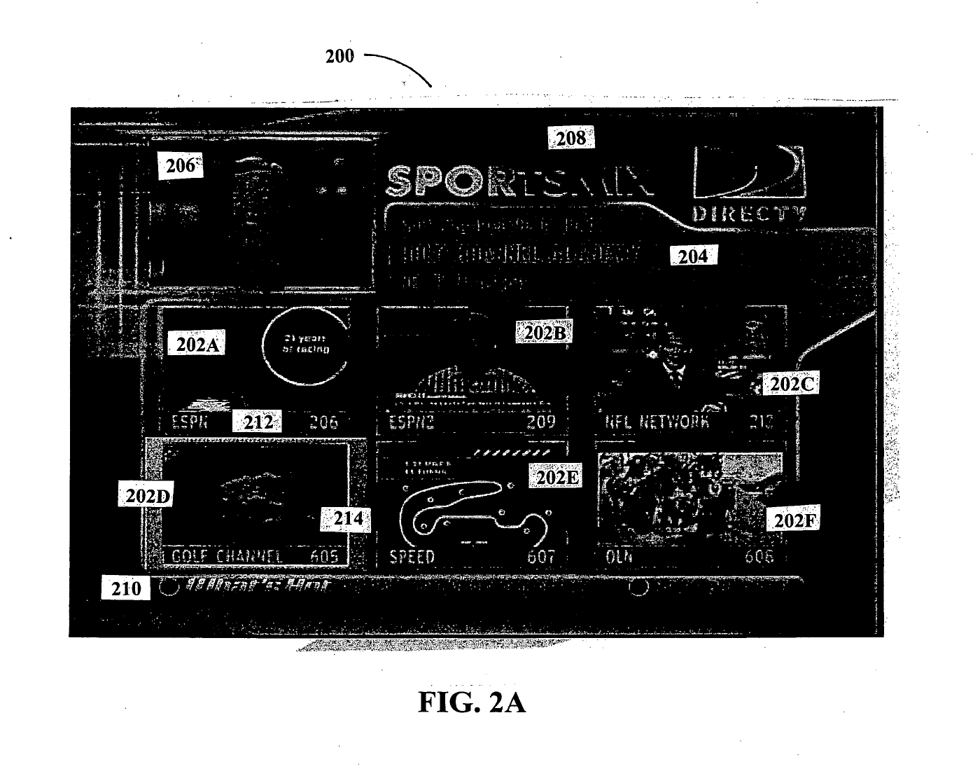

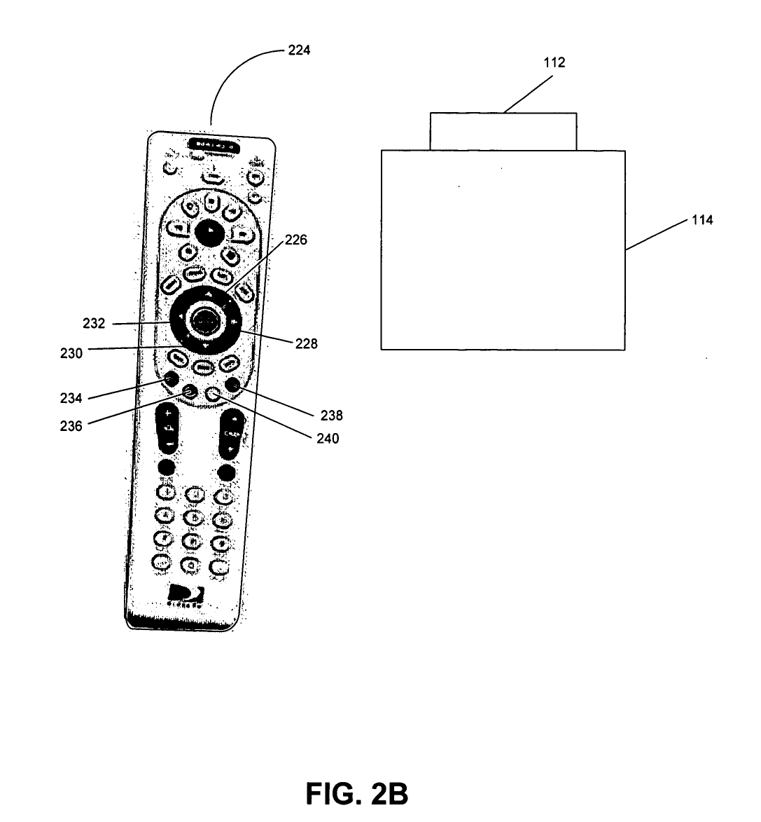

FIG. 2A illustrates a typical matrix with a generic video feed in accordance with the present invention.

Interactive mosaic channel 200 is shown as being displayed on monitor 114. Within interactive mosaic channel 200, there are a number of video cells 202A-202F and a text box 204, also referred to as an On Screen Display (OSD) 204. Optionally, the interactive mosaic channel 200 further comprises a separate video cell 206, also called a “barker cell” 206, a background video 208, and a control bar 210. The video cells 202A-F optionally comprise a channel identification (channel ID) portion 212. Further, cursor 214 is also optionally included to allow for interaction with each of the video cells 202A-202F and barker cell 206.

The number of video cells 202A-F can change based on the number of video cells 202 A-F desired. As the number of video cells 202A-F increases, of course, there must be a reduction in the size of the video cells 202A-F to ensure that the video cells are differentiated on the monitor 114. As the number of video cells 202A-F decreases, the size of the video cells 202A-F can increase, since there is more space available on monitor 114 to display video cells 202A-F.

Further, the placement of video cells 202A-F, barker cell 206, text box 204, and control bar 210 is not limited to the positions on monitor 114 as shown in FIG. 2A. These elements can be displayed anywhere on monitor 114 without departing from the scope of the present invention.

As there are multiple video feeds and video cell 202A-F and barker cell 206 being presented, each video cell 202A-F and barker cell 206, as well as background video 208 and possibly control bar 210, have associated audio portions that can be played. Presenting more than one audio stream may be confusing; as such, it is typical that only one audio stream of information is presented at a given time. However, each of the video feeds may also have closed-captioning information associated with it, and selection of a closed-captioned presentation, rather than an audio presentation, can be performed as described herein.

Video Cells

Video cells 202A-F each comprise a separate viewer channel of programming. So for example, in an interactive mosaic channel that is focused on news programming, cell 1 could contain the video programming associated with the viewer channel of FOX News Channel, cell 2 could contain the video programming associated with the viewer channel of CNN, cell 3 could contain the video programming associated with the viewer channel of Headline News, cell 4 could contain the video programming associated with the viewer channel of MSNBC, cell 5 could contain the video programming associated with the viewer channel of The Weather Channel, and cell 6 could contain the video programming associated with the viewer channel of C-SPAN. The placement and video programming content for each video cell 202A-F can depend on a wide variety of factors, such as Nielsen ratings for a given channel, whether a given channel is available on a specific viewer's programming package, viewer channel number (lowest to highest or highest to lowest) or can be decided or changed based on programming that is present on one or more of the viewer channels available for the interactive mosaic channel. For example, and not by way of limitation, an important vote on the floor of the Senate may be taking place, and a decision can be made to change the placement of C-SPAN from video cell 202F to video cell 202A for a period of time. Changes in presentation for the interactive mosaic channel 200 are discussed below.

Within each of the video cells 202A-F is a channel identification (ID) box 212. Typically, the channel ID box 212 indicates to the viewer the moniker or name that is associated with the video feed being shown in that respective video cell 202A-F, and the viewer channel number associated with the video feed being shown in that respective video cell 202A-F. For example and not by way of limitation, in video cell 202A, which as described above, is showing the video feed for ESPN, channel ID box 212 would indicate “ESPN” as well as, optionally, a channel number, e.g., “206” to indicate to the viewer that the video feed being shown in video cell 202A is that of ESPN, and that the viewer is accustomed to seeing this full-monitor 114 video programming on viewer channel 206.

Other information may also appear in channel ID box 212, such as an indication that the video feed that is being presented in the associated video cell 202A-F is a “user favorite” channel, the channel ID box 212 may be presented in a different color or video texture to indicate that the video feed that is being presented in the associated video cell 202A-F is a channel that presents programming that adults may wish to block from their children's view or has closed-captioning available, etc. Many possibilities are available within the scope of the present invention to present various types of video information within channel ID box 212 for viewer selection and benefit. The channel ID box 212 may also appear without a video cell 202A-F for those video feeds that are channel blocked via parental control, or otherwise unavailable to a specific viewer because of the viewer's programming package or other reasons.

Text Box

Text box 204 contains textual information that is useful to the viewer, and this information can change depending on the viewer's selection of interactive services as described herein. For example, the text box 204 can contain a generic statement about the genre of the interactive mosaic channel 200, or statements directed to a selected video cell 202A-F or information related to the channel ID box 212 to describe to a user the meaning of the information presented in the channel ID box 212 or other information related to the video cell 202A-F and channel ID box 212. The text box can also scroll to present additional information to the viewer that does not all fit within text box 204 at a given time.

There can also be default text associated with each interactive mosaic channel 200, and, depending on the capabilities of IRD 112, each time an interactive mosaic channel 200 is tuned to, a default descriptive text shall be displayed in the text box 204.

Barker Cell

Barker cell 206 is a presentation of video data that can relate to the video cells 202A-F that are present in interactive mosaic channel 200. For those interactive mosaic channels 200 that have the optional barker cell 206, the barker cell 206 can use audio or video clues to direct the user to one of the video cells 202A-F for more information on a given topic, or provide an overview of the information presented within the video cells 202A-F. For example, the audio and video associated with barker cell 206 in a news format can be a series of stories that are being covered in more depth on the viewer channels being shown in video cells 202A-F, and the barker cell 206 audio and video can then direct the viewer to tune the IRD 112 or monitor 114 to a specific video cell 202A-F for more information on that topic. The barker cell 206 can also be used to provide an overview of the news stories, either those presented in video cells 202A-F or other news stories of interest, without directing the viewer to one of the video presentations being discussed in the video feeds shown in video cells 202A-F.

Barker cell 206 can present audio and video information that is not available on any other viewer channel that is accessible to IRD 112 or monitor 114, other than within the barker cell 206 of the interactive mosaic channel 200. When the barker cell 206 presents audio and video information that is not present on any other viewer channel accessible to IRD 112 or monitor 114, then the barker cell 206 does not have an associated channel ID box 212.

Background Video

Background video 208 is typically a backdrop for the interactive mosaic channel 200. The background video 208 can be related to the genre of the interactive mosaic channel 200; for example, in a news environment, the background video 208 can be related to a top news story, the stock market exchange building, a prominent government building, etc. The background video 208 can be changed or can be a dynamic video depending on the desires of the editorial staff or viewer preferences. Further, the background video 208 can be a logo or other indicator of the source of the interactive mosaic channel 200, such as DIRECTV.

Interactive Features

FIG. 2B illustrates a remote control used in the present invention.

Typically, IRD 112 and monitor 114 are controlled by a remote control device 224, which allows viewers a convenient way to control audio volume, channel selection, and other features and display characteristics from a distance away from the IRD 112 and/or monitor 114.

Each video cell 202A-F has an associated channel ID box 212, and one of the video cells, cell 202D, has a cursor 214 surrounding that specific video cell 202 and, optionally, channel ID box 212. The cursor 214 indicates that the specific video cell 202 and channel ID 212 has been selected by the viewer. The cursor 214 is typically controlled by buttons 226-232, but can be controlled by other buttons on the remote control 224 if desired.

By selecting a given video cell 202A-F, the viewer is selecting a specific characteristic associated with that given video cell 202A-F, or associated video feed used to generate that video cell 202A-F. In most instances, when the viewer selects a given video cell 202, the audio portion associated with the selected video cell 202 will be presented to the viewer, rather than the audio portion associated with the barker cell 206 or a generic audio track that is associated with interactive mosaic channel 200. Further, selection of a given video cell 202A-F with cursor 214 may also select a closed captioning data stream associated with the selected video cell 202, depending on the availability of such a data stream and/or other settings that a viewer has selected. Cursor 214 can be moved to any of the video cells 202A-F, and, optionally, can be moved to select text box 204 or control bar 210.

When cursor 214 is moved to a given video cell 202A-F via buttons 226-232, text box 204 also may undergo a change in information. Typically, when the video cell 202A-F is selected by the viewer, indicated by the presence of cursor 214, text box 204 will present the information in the Advanced Program Guide (APG) that is associated with the viewer channel selected by cursor 214. The APG typically includes information on the program or “show” that is currently being presented by the viewer channel shown in video cell 202A-F, as well as the time that show is being aired and the next show to be aired on that viewer channel. Other information, either in the APG or external to the APG, can also be displayed in the text box 204 when the cursor is moved to a given video cell 202A-F.

As such, the viewer can “interact” with the interactive mosaic channel 200 and decide which audio track to listen to, find out a plot line of each of the shows being presented in the various video cells 202, find out what is going to be aired next in the various viewer channels being presented in video cells 202, or listen to generic audio from the barker cell 206 or associated with the interactive mosaic channel 200 itself while variously viewing the video presentations in the video cells 202. If a specific video cell 202 presents video information that is of interest to a viewer, then the viewer can move cursor 214, via a remote control command, to a given video cell 202, and listen to the audio associated with that video cell 202 and find out more about that viewer channel in text box 204.

If the viewer decides that the selected video cell 202 is of enough interest, the viewer can then directly tune to the selected video cell 202, i.e., tune directly to that viewer channel that is providing the video and audio used to create video cell 202, by pressing a single button on the remote control 224 (typically the “select” button on a DIRECTV remote control). This will tune the IRD 112 or monitor 114 to that viewer channel, which will then be presented full-screen to the viewer as in a normal television monitor 114 viewing format.

The barker cell 206, since it typically contains audio and video information that is not located on any viewer channel other than the interactive mosaic channel 200, cannot typically be selected for full screen viewing by the viewer on monitor 114. However, the barker cell 206 can be selected for full monitor 114 viewing, or at least enough of the monitor 114 to allow for changes in the video cells 202 as described below, to allow for changes in the interactive mosaic channel 200 and in the control bar 210 in near-real-time.

Control Bar

The Control Bar 210 (also called the Attract Icon or the Attract Icon Bar) The control bar 210 allows for instant, on-screen access to several data sources that allow the viewer to access data related to that being shown in the video cells 202A-F as well as other viewer channels available within system 100. Those IRDs 112 that have interactive capabilities have special buttons that correspond to the icons that appear on the control bar 210. Each icon/button directs the viewer to a different screen, such as special events, or, in the case of the present invention, data related to real-time or near-real-time viewership of channels within system 100. Each screen can have sub-screens that further allow related data to be viewed or otherwise analyzed by the viewer.

For example, and not by way of limitation, one of the remote control 224 buttons, e.g., the “red” button 234, indicated by text and/or graphics on control bar 210, may take a viewer to the “What's Hot” page, where viewers can review data related to viewership of shows currently being aired within system 100.

Similarly, a “special” page can be accessed by pressing a different button on the remote control 224, e.g., the “green” button 236, or the blue button 238 or yellow button 240, where viewers can view a channel or other data page. The special page can be reprogrammed by the system provider or the viewer based on time, or, in the case of interactive mosaic channel 200, can be done by genre. For example, and not by way of limitation, the special page can be assigned to the NCAA bracket for a “Sports” mosaic channel 200, and, if the viewer changes to a “News” mosaic channel 200, the special page can be a breaking news channel or news recap video loop that is provided by the system provider. There can be more than one special “page” that is accessible from the buttons 234-240, or other buttons on the remote control 224, if desired.

Monitor Displays

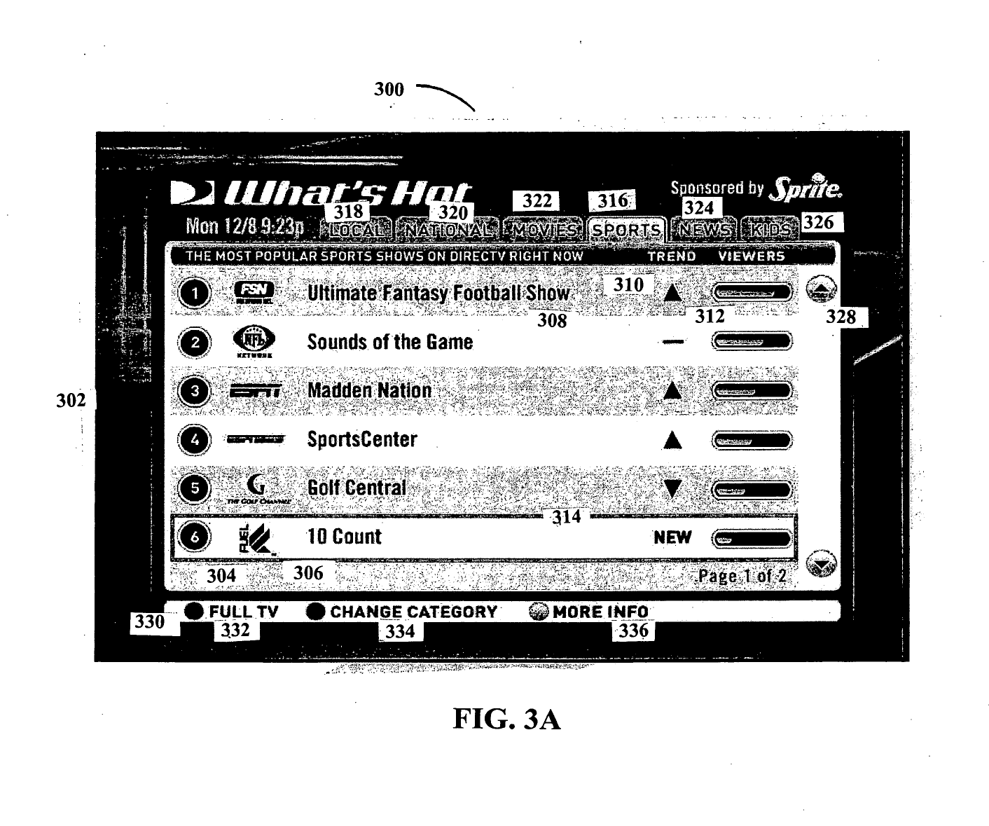

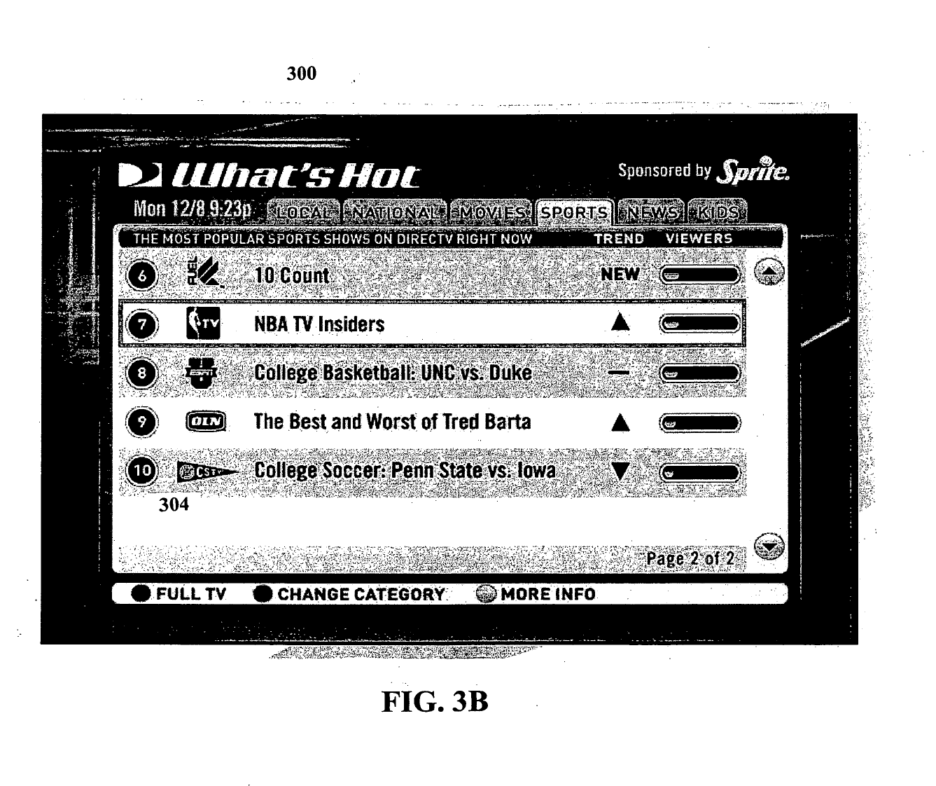

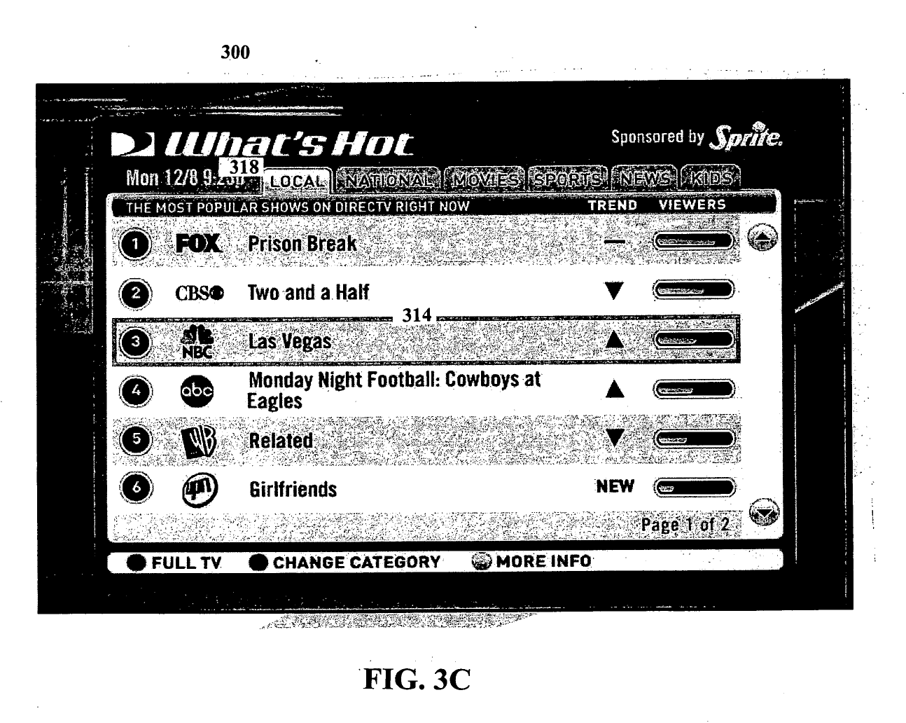

FIGS. 3A-3C illustrate on-monitor displays of data presentation pages in accordance with the present invention.

Page 300 is illustrated, with screen 302, popularity indicator 304, network icon 306, show name 308, trend indicator 310, viewership legend 312, cursor 314, and tabs 316-326. Scroll bar 328 and control bar 330 with icons 332-336 are also shown on page 300.

Screen 302 indicates via popularity indicator 304 the top shows that are being currently aired in system 100 by genre, the genre being indicated by a highlighted tab 316-326. For example, as shown in FIG. 3A, Sports tab 316 is highlighted. Depending on how page 300 is reached, a different tab 316-326 can be highlighted. For example, if page 300 is reached from a mosaic channel 200 that is sports related, the sports tab 316 may be the default tab. Other mosaic channels 200, or other channels in general, may reach different default tabs 316-326. For example, and not by way of limitation, if the page 300 is reached from a local station channel, the default tab may be tab 318; if the page 300 is reached from the same local station during a time period of the national news broadcast, the default tab may be the national tab 320, or the news tab 324. Default tabs 316-326 can be set by the system provider or the viewer based on several factors, including viewer preferences, time period, and channel origination of the page 300 request.

Network icon 306 helps to indicate which network or channel is broadcasting the most popular show, and the program name 308 also indicates to the viewer the program that is currently being aired. Trend indicator 310 shows whether over a given recent time period, whether the viewership of that show has gone up or down, or if it is a new show in the top show lineup on page 300. Viewers indicator 312 shows a relative viewership share, or a pure number of viewers, depending on what is desired by the system provider or viewer.

Cursor 314 allows the viewer to select a given top show for additional information on that show. As shown in FIG. 3A, popularity icon 304 #6, which is a new show in the top lineup, is titled “10 Count” and is currently selected by cursor 314. Now, when icons 332-336 are selected, some of the icons will direct the viewer to, for example, when icon 332, the “red button” 234, is selected, the cursor 314 highlighted show will be sent to full screen on monitor 114. If icon 336, the yellow button 240, is selected, more information on the cursor 314 highlighted show will be displayed, such as APG information or other information on the selected show that is resident within system 100. If icon 334, e.g., the green button 236 is selected, the tabs 316-326 are sequentially or otherwise parsed to see the top shows in other categories.

By using scroll bar 328, either by using the cursor keys 226-232 on remote control 224 or by other methods, FIG. 3B is arrived at, which shows additional shows that are in the top viewership category for a given tab 316-326. The same show may appear in different popularity icon 304 positions depending on which tab 316-326 is selected.

FIG. 3C illustrates selection of a different category, namely, the local category as indicated by the highlighted local tab 318, where different currently airing shows are displayed on screen 300. Selection of icon 334 allows the viewer to scroll through the tabs 316-326, which will display the different popular shows based on the criteria defined by tabs 316-326.

Within screen 302 as shown in FIGS. 3A-3C, the time and date can be displayed, as well as an advertisement for a sponsor or an upcoming “hot event” that will be airing in the future, such as a special sporting event like the Super Bowl, the Olympics, the NCAA Men's Basketball tournament, or other events that may be selectable by using buttons on the remote control 224.

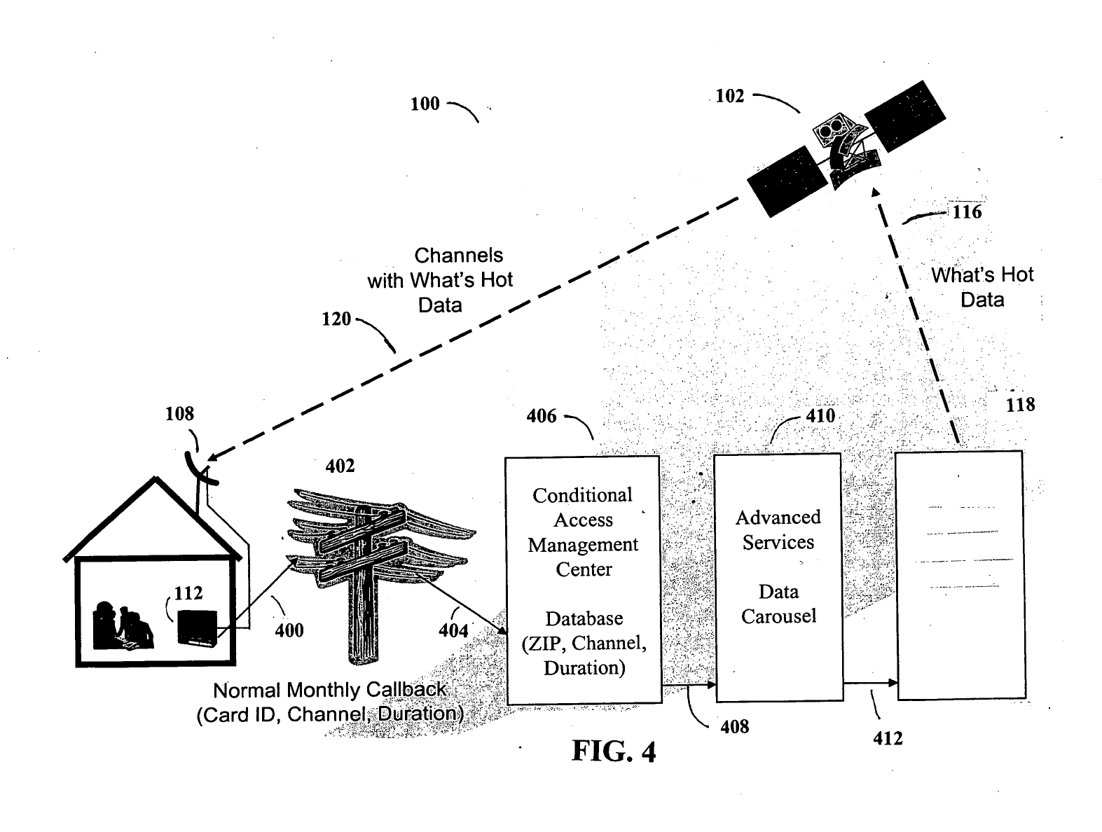

FIG. 4 shows a typical data flow for the present invention.

System 100 is shown, now with callback information 400 being transmitted from IRD 112 through telephone wires 402 and link 404 to conditional access management center 406. Each IRD 112 that is connected to telephone wires 402 makes a periodic call into the conditional access management center 402 to obtain updates to conditional access codes, request pay-per-view events, and other reasons. Typically, the call in is performed on a monthly basis, but can be performed on a daily or hourly basis if desired. At the center 406, the IRD 112 identification number, current channel information, duration that the IRD was on a given channel, etc., is cross-referenced to the zip code for a given IRD 112. Once the zip code information is obtained, the card ID for that IRD is removed from the data packet 408 that is passed along to the advanced services data center 410, such that individual viewers information is no longer accessible. The advanced services center 410 then amalgamates the data packets 408 from the various viewers, and places it into the proper format to be included with the viewership data pages 300 described herein. Uplink center 118 then sends this data on uplink signals 116 to satellites 102-106 (for ease of understanding, only satellite 102 is shown), and this data is sent down via downlink signals 120 to IRD 108. The viewership data can be sent on mosaic channels 200, or on regular channels as a control bar 110 that is accessible from any channel that is received and demodulated by IRD 112, as well as being accessible from other portions of the data viewable on monitor 114, e.g., guide data.

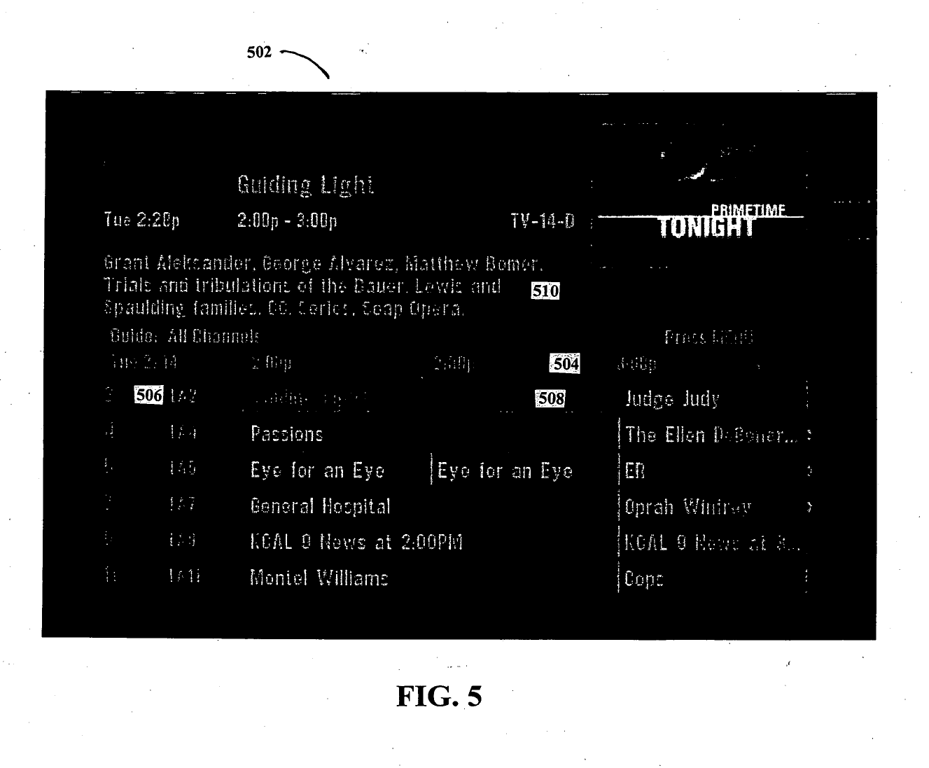

FIG. 5 shows a guide data display of the present invention.

The present invention allows for mirroring of the live viewership data shown on the screens depicted in FIGS. 3A-3C onto the guide data display shown in FIG. 5 that is used by viewers to find out what shows are on. For example, the guide data screen 502, which is typically a listing of all shows that are currently being broadcast, is typically displayed by ascending channel number. So, for a given time slot 504, channel number 506 is shown, and cursor 508 can be placed on a given show for a given channel 506 which then gives additional information about the highlighted show in text box 510. For example, and not by way of limitation, in channel 506 listing, Channel 2 is shown first, then channel 3, channel 4, etc. Within the guide data screen 502, those shows that are top rated shows can be highlighted when displayed on monitor 114, or have popularity indicator 304 or other indicator displayed along with the guide data screen 502, e.g., in channel indicator 506, in text box 510, or elsewhere on guide data screen 502, to indicate to a viewer that a particular show is one of the most popular shows being viewed at the time the guide data screen 502 is being presented.

Further, the live viewership data can be shown for all of the programs listed in the guide data screen 502 presentation, regardless of whether a given show is in the top viewership ratings. So, even a show that is rated at the forty-third most popular show would have a popularity indicator 304 or other indicator that would inform the viewer that the show in question is “43rd” in popularity. Other indicators, such as trend indicator 310, viewership legend 312, or other indicators can also be included with the guide data screen 502 without departing from the scope of the present invention.

Within the guide data screen 502 presentation, the control bar 210 can also be displayed such that the genre tabs 316-326 can be accessed directly from the guide data presentation.

Conclusion

The present invention comprises a viewership rating system presented on a monitor. A system in accordance with the present invention comprises a program guide, presented on the monitor, wherein the program guide comprises a plurality of broadcast programs, and a plurality of rating indicators, each of the plurality of rating indicators presented on the monitor in a respective fashion with the plurality of broadcast programs, wherein the plurality of rating indicators shows a relative popularity of each of the plurality of broadcast programs.

Such a system further optionally includes the current viewership being determined by callback information gathered from a plurality of receivers that are receiving the broadcast programs, a cursor, wherein the cursor can select one of the plurality of broadcast programs, selection of one of the broadcast programs from the plurality of broadcast programs creating a new condition to be displayed on the monitor, the new condition comprising presenting the selected broadcast program on the monitor, an indicator showing a trend related to at least one broadcast program in the plurality of broadcast programs, the dynamic viewership rating system being accessed by a selection of a remote control guide button, and a separate remote control button selecting a separate page display directly from a guide data display.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description.

What is claimed is:

1. A viewership rating system presented on a monitor comprising:
a program guide, presented on the monitor, wherein the program guide comprises a plurality of broadcast programs; and
a plurality of rating indicators, each of the plurality of rating indicators presented on the monitor in a respective fashion with the plurality of broadcast programs, wherein the plurality of rating indicators shows a relative popularity of each of the plurality of broadcast programs.

2. The viewership rating system of claim 1, wherein the current viewership is determined by callback information gathered from a plurality of receivers that are receiving the broadcast programs.

3. The viewership rating system of claim 2, further comprising a cursor, wherein the cursor can select one of the plurality of broadcast programs, selection of one of the broadcast programs from the plurality of broadcast programs creating a new condition to be displayed on the monitor.

4. The viewership rating system of claim 3, wherein the new condition comprises presenting the selected broadcast program on the monitor.

5. The viewership rating system of claim 4, further comprising an indicator showing a trend related to at least one broadcast program in the plurality of broadcast programs.

6. The viewership rating system of claim 5, wherein the dynamic viewership rating system is accessed by a selection of a remote control guide button.

7. The viewership rating system of claim 6, wherein a separate remote control button selects a separate page display directly from a guide data display.

8. An apparatus for determining a dynamic viewership rating of a plurality of broadcast programs, comprising:
a broadcast delivery system, comprising a transmitter and a receiver;
a monitor, coupled to the receiver, for selectively displaying the plurality of broadcast programs and for selectively displaying guide data related to the plurality of broadcast programs; and
a feedback system, coupled to the receiver, wherein the feedback system provides statistics about a popularity of a selected broadcast program which is viewed on the monitor in conjunction with the guide data.

9. The apparatus of claim 8, wherein the broadcast delivery system is a satellite television delivery system.

10. The apparatus of claim 9, wherein the statistics comprise a trend statistic for each of the plurality of broadcast programs.

11. The apparatus of claim 10, wherein the statistics further comprise an indication of a number of other viewers that are viewing each of the plurality of broadcast programs.

12. The apparatus of claim 11, wherein the plurality of broadcast programs are presented by genre.

13. The apparatus of claim 12, wherein the feedback system is a telephone callback system.

14. The apparatus of claim 13, wherein the statistics are accessed by a selection of a remote control command button.

15. The apparatus of claim 14, further comprising a control bar, displayed on the monitor, for assisting viewers in selection of viewing of the statistics.

16. The apparatus of claim 15, wherein the statistics are presented based on geographical location of the other viewers.
